(19) United States
(12) Patent Application Publication
(10) Pub. No.: US 2015/0002415 A1
(43) Pub. Date: Jan. 1, 2015

(54) TOUCH PANEL INCLUDING ACTIVE STYLUS PEN AND CONTROLLING METHOD THEREOF

(71) Applicant: SAMSUNG ELECTRO-MECHANICS CO., LTD., Suwon-Si (KR)

(72) Inventors: Hyun Suk Lee, Suwon-Si (KR); Tah Joon Park, Suwon-Si (KR); Yong II Kwon, Suwon-Si (KR)

(73) Assignee: SAMSUNG ELECTRO-MECHANICS CO., LTD., Suwon-Si (KR)

(21) Appl. No.: 14/250,185

(22) Filed: Apr. 10, 2014

(30) Foreign Application Priority Data
Jun. 28, 2013 (KR) 10-2013-0075900

(51) Int. Cl. G06F 3/0354; G06F 3/041

(52) U.S. Cl. CPC G06F 3/03545; G06F 3/041
USPC 345/173

(57) ABSTRACT

Disclosed herein is a touch panel including an active stylus pen, including: a touch panel including a plurality of first electrode patterns and second electrode patterns formed on a substrate in directions in which they intersect with each other; a controller controlling a first driving signal applied to the second electrode patterns and detecting a change in mutual capacitance between the first and second electrode patterns; and the active stylus pen configured separately from the touch panel, and receiving a synchronizing signal from the touch panel when it hovers over or touches the touch panel, generates a second driving signal synchronized with the first driving signal, and outputs the generated second driving signal to the hovering or touching point.

### CROSS REFERENCE TO RELATED APPLICATION

This application claims the benefit of Korean Patent Application No. 10-2013-0075900, filed on Jun. 28, 2013, entitled “Touch Panel Including Active Stylus Pen and Controlling Method Thereof”, which is hereby incorporated by reference in its entirety into this application.

### BACKGROUND OF THE INVENTION

1. Technical Field

The present invention relates to a touch panel including an active stylus pen and a controlling method thereof.

2. Description of the Related Art

In accordance with the grown of computers using a digital technology, devices assisting computers have also been developed, and personal computers, portable transmitters and other personal information processors execute processing of text and graphics using various input devices such as a keyboard and a mouse.

However, current techniques for input devices have progressed toward techniques related to high reliability, durability, innovation, designing and processing beyond the level of satisfying general functions. To this end, a capacitive type touch panel has been developed as an input device capable of inputting information such as text, graphics, or the like.

In addition, the touch panel is classified into a resistive type touch panel, a capacitive type touch panel, an electromagnetic type touch panel, a surface acoustic wave (SAW) type touch panel, and an infrared type touch panel. These various types of touch panels are adapted for electronic products in consideration of a signal amplification problem, a resolution difference, a level of difficulty of designing and processing technologies, optical characteristics, electrical characteristics, mechanical characteristics, resistance to an environment, input characteristics, durability, and economic efficiency. Currently, the resistive type touch panel and the capacitive type touch panel have been prominently used in a wide range of fields.

In addition, in accordance with an increase in a screen size in a mobile device, the demand for a touch system capable of accommodating various types of touch inputs has gradually increased, and functions capable of displaying an accurate touch position even with a small touch input such as a stylus pen and processing various signal inputs such as pressure by the stylus pen, or the like, have been demanded.

Therefore, according to the prior art, as disclosed in the following Prior Art Document (Patent Document), in order to prevent interference with a driving signal applied to a touch panel, the stylus pen has generated and used a driving signal having a frequency different from that of the driving signal, such that a separate sensing circuit unit for the driving signal of the stylus pen is required in a touch module. In addition, in order to transmit sensed data sensed by a pressure sensor, or the like, included in the stylus pen to a touch module, a separate communicating module is included in the stylus pen, such that a manufacturing cost is increased.

### PRIOR ART DOCUMENT

### Patent Document

(Patent Document 1) 2012-0154340US

### SUMMARY OF THE INVENTION

The present invention has been made in an effort to provide a touch panel including an active stylus pen in which a separate sensing circuit unit and communicating module for a driving signal and sensed data of the active stylus pen are not required in a touch module, and a controlling method thereof.

According to a preferred embodiment of the present invention, there is provided a touch panel including an active stylus pen, including: a touch panel including a plurality of first electrode patterns and second electrode patterns formed in directions in which they intersect with each other; a controller controlling a first driving signal applied to the touch panel and detecting a change in mutual capacitance between the first and second electrode patterns by a touch input; and the active stylus pen configured separately from the touch panel, and receiving a synchronizing signal from the touch panel when it hovers over or touches the touch panel, generates a second driving signal synchronized with the first driving signal, and outputs the generated second driving signal to the hovering or touching point.

The controller may include: a driving circuit module applying a predetermined driving signal to the first electrode patterns; a sensing circuit module sensing the change in mutual capacitance generated between the first and second electrode patterns and generating an analog signal corresponding to the change; a signal converting module converting the analog signal into a digital signal; a calculating module calculating a coordinate of the touch input applied to the touch panel using the digital signal; and a first controlling unit controlling the driving circuit module, the sensing circuit module, and the signal converting module, and the calculating module.

The active stylus pen may include: a synchronizing signal receiving unit receiving the synchronizing signal from the touch panel; a driving signal applying unit generating a second driving unit to be applied to the touch panel after the reception of the synchronizing signal; a pressure sensing unit sensing pressure when the active stylus pen touches the touch panel; and a second controlling unit controlling the synchronizing signal receiving unit, the driving signal applying unit, and the pressure sensing unit.

The second driving signal may have the same frequency as that of the first driving signal.

The second controlling unit may generate a third driving signal based on data on a pressure value sensed by the pressure sensing unit.

The sensing circuit module may include a comparator.

According to another preferred embodiment of the present invention, there is provided a controlling method of a touch panel including an active stylus pen, including: a touch recognizing step of detecting a change in mutual capacitance between first and second electrode patterns depending on a touch input according to a first driving signal sequentially applied to the touch panel to determine a position of the touch input; a second driving signal generating step of allowing the active stylus pen hovering over or touching the touch panel to receive a synchronizing signal from the touch panel and generate a second driving signal synchronized with the first driving signal, after the touch recognizing step; and a coordinate measuring step of the active stylus pen of detecting a change in mutual capacitance at the hovering or touching point by the active stylus pen to determine a coordinate of the hovering or touching point.

The first and second driving signals may have the same frequency as each other.

The second driving signal generating step may include: receiving, by a synchronizing signal receiving unit, the synchronizing signal from the touch panel after the touch recognizing step ends; and generating, by a driving signal applying unit, the second driving signal to be applied to the touch panel after the receiving of the synchronizing signal.

The coordinate measuring step of the active stylus pen may include: applying, by the active stylus pen, the second driving signal to the hovering or touching point on the touch panel; and detecting the change in the mutual capacitance at the point to which the second driving signal is applied to determine a coordinate of the point.

The controlling method may further include, after the coordinate measuring step of the active stylus pen, generating a third driving signal based on pressure data sensed by a pressure sensing unit and applies the generated third driving signal to the touch panel.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a touch panel including an active stylus pen according to a preferred embodiment of the present invention;

FIG. 2 is a block diagram showing a controller according to the preferred embodiment of the present invention;

FIG. 3 is a block diagram showing the active stylus pen according to the preferred embodiment of the present invention;

FIGS. 4A and 4B are views showing a synchronizing process between the touch panel and the active stylus pen according to the preferred embodiment of the present invention;

FIG. 5 is a view for describing a process of driving the active stylus pen according to preferred embodiment of the present invention;

FIG. 6 is a view for describing communication of pressure data in the case in which the active stylus pen according to the preferred embodiment of the present invention touches the touch panel;

FIGS. 7A and 7B are views showing, respectively, modulated and encoded signals of sensed data measured by a pressure sensing unit according to the preferred embodiment of the present invention;

FIG. 8 is a view showing a sensing circuit module according to the preferred embodiment of the present invention; and

FIG. 9 is a flow chart showing a controlling method of a touch panel including an active stylus pen according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

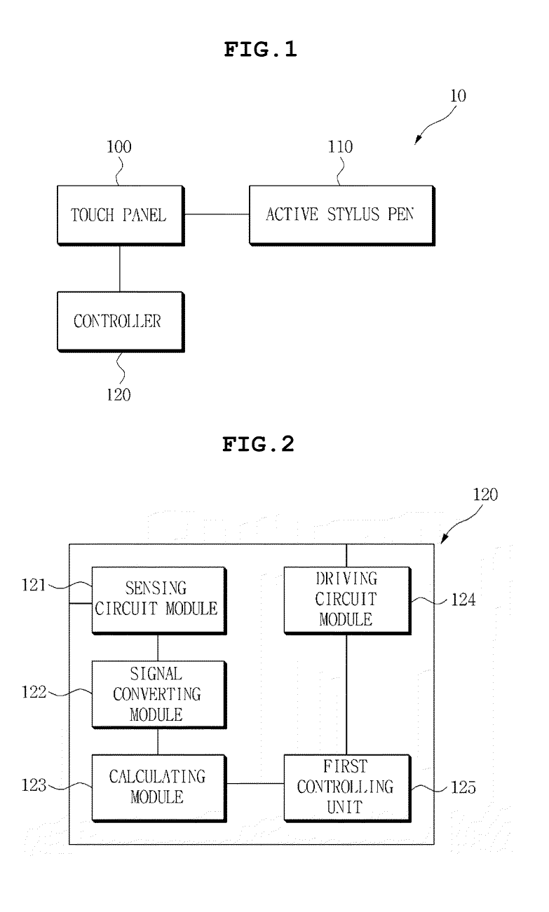

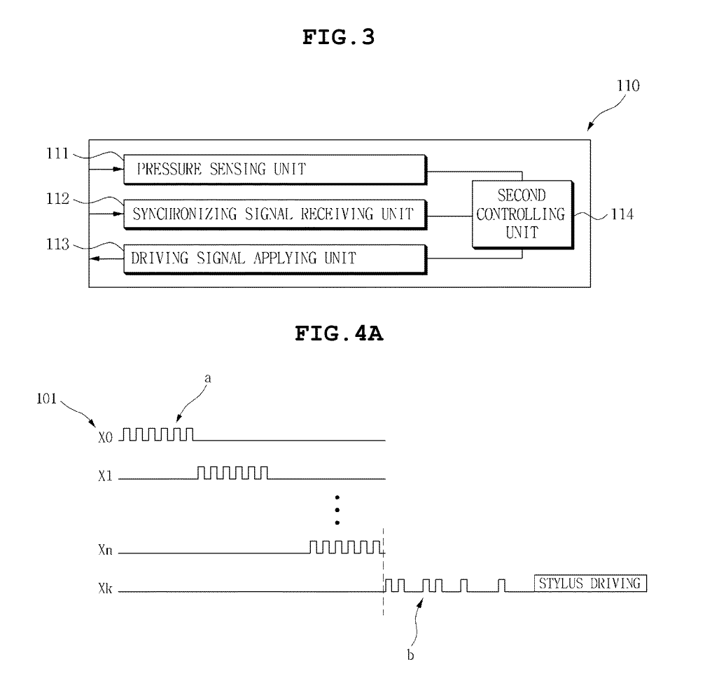

FIG. 1 is a block diagram of a touch panel including an active stylus pen according to a preferred embodiment of the present invention; FIG. 2 is a block diagram showing a controller according to the preferred embodiment of the present invention; and FIG. 3 is a block diagram showing the active stylus pen according to the preferred embodiment of the present invention.

As shown in FIGS. 1 to 3, the touch panel including an active stylus pen is configured to include a touch panel, a controller, and the active stylus pen, wherein the controller includes a sensing circuit module, a signal converting module, a calculating module, a driving circuit module, and a first controlling unit, and the active stylus pen includes a pressure sensing unit, a synchronizing signal receiving unit, a driving signal applying unit, and a second controlling unit.

The touch panel 100 may include a substrate (not shown), first electrode patterns 101 formed on one surface of the substrate so as to be in parallel with each other in one direction, and second electrode patterns 102 formed on a rear surface of the substrate so as to be in parallel with each other in a direction in which they intersect with the first electrode patterns 101, wherein the first and second electrode patterns 101 and 102 may be formed in a mesh pattern or a solid type of bar electrode structure using copper (Cu), aluminum (Al), gold (Au), silver (Ag), titanium (Ti), palladium (Pd), chrome (Cr), or a combination thereof.

The controller 120 applies a first driving signal a to the touch panel 100 and senses a change in mutual capacitance between the first and second electrode patterns 101 and 102 by a touch input on the touch panel 100 to detect a coordinate of the touch input. Here, the controller 120 may include a sensing circuit module 121, a signal converting module 122, a calculating module 123, a driving circuit module 124, and a first controlling unit 125.

The sensing circuit module 121 senses a change in mutual capacitance between the first and second electrode patterns 101 and 102 by a touch input and generates an analog signal (voltage form) corresponding to the change, the signal converting module 122 converts the analog signal (voltage form) into a digital signal, the calculating module 123 judges a coordinate, or the like, of the touch input to the touch panel 100 using the digital signal, and the driving circuit module 124 applies the first driving signal a to the first electrode patterns 101. Here, the sensing circuit module 121 may include a comparator 127 for decoding pressure data sensed in the active stylus pen 110.

In addition, the first controlling unit 125 may control the sensing circuit module 121, the signal converting module 122, the calculating module 123, and the driving circuit module 124 and be a micro controller unit (MCU).

The active stylus pen 110 is configured separately from the touch panel 100, and receives a synchronizing signal b from the touch panel 100 when it hovers over or touches the touch panel 100, generates a second driving signal c, and applies the generated second driving signal c to the touch panel 100. Here, the active stylus pen 110 may include a pressure sensing unit 111, a synchronizing signal receiving unit 112, a driving signal applying unit 113, and a second controlling unit 114.

The synchronizing signal receiving unit 112 receives the synchronizing signal b from the touch panel 100 after a scan process for sensing the touch input in the touch panel 100 ends, the driving signal applying unit 113 generates the second driving signal c or a third driving signal e to be applied to the touch panel 100 after the reception of the synchronizing signal b, the pressure sensing unit 111 senses pressure when the active stylus pen 110 touches the touch panel 100, and the second controlling unit 114 controls the synchronizing signal receiving unit 112, the driving signal applying unit 113, and the pressure sensing unit 111. Here, the second driving signal c has the same frequency as that of the first driving signal a, and the second controlling unit 114 modulates data on a pressure value sensed by the pressure sensing unit 111 into the third driving signal e.

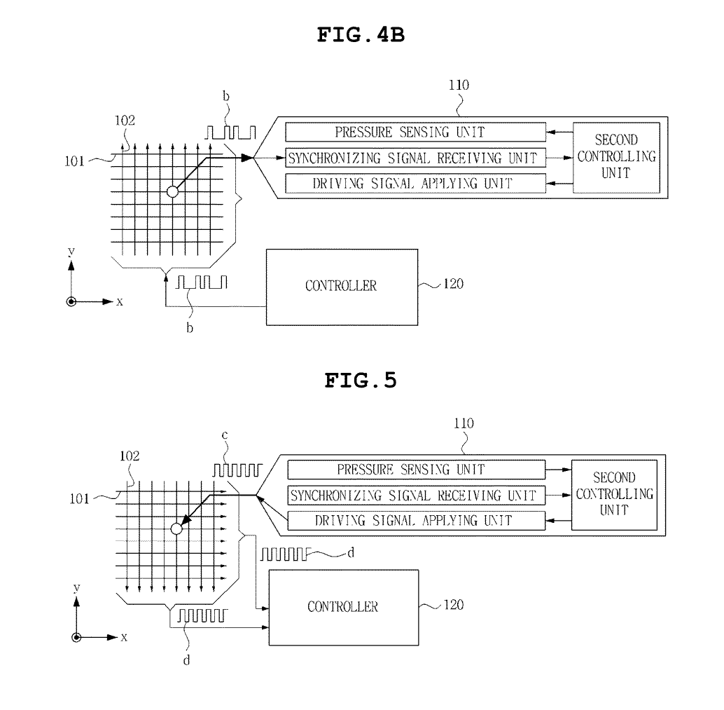

Hereinafter, a driving method of a touch panel including an active stylus pen will be described in detail with reference to FIGS. 4A to 5 and 9.

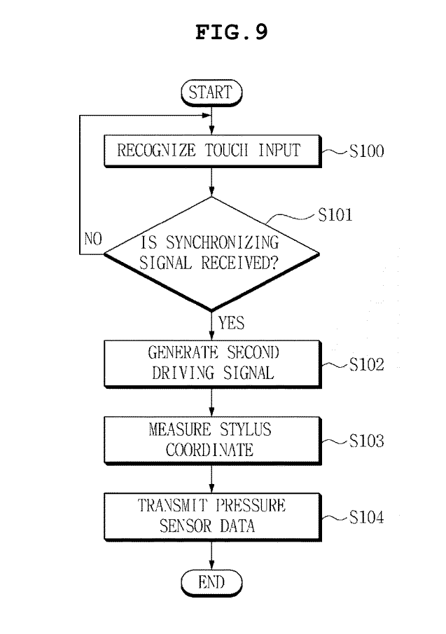

FIGS. 4A and 4B are views showing a synchronizing process of the touch panel including an active stylus pen according to the preferred embodiment of the present invention; FIG. 5 is a view for describing a process of driving the active stylus pen according to preferred embodiment of the present invention; FIGS. 7A and 7B are views showing, respectively, modulated and encoded signals of sensed data measured by a pressure sensing unit according to the preferred embodiment of the present invention; and FIG. 9 is a flow chart showing a controlling method of a touch panel including an active stylus pen according to the preferred embodiment of the present invention.

As shown in FIGS. 4A and 9, the controller 120 applies the first driving signal a to the first electrode patterns 101 X₀ to X_{N} to perform driving for detecting whether or not the touch input onto the touch panel 100 is present (S100) and generates the synchronizing signal b in the case in which the touch input is not detected during the driving and transmits the generated synchronizing signal b to the active stylus pen 110 through the touch panel 100. That is, the first controlling unit 125 controls the driving circuit module 124 and the sensing circuit module 121 to sequentially apply the first driving signal a to the first electrode patterns 101 X₀ to X_{N} and sense a first sensed signal (not shown) according to a change in mutual capacitance between the first and second electrode patterns 101 and 102, thereby detecting a coordinate of the touch input.

Further, as shown in FIGS. 4B and 9, the active stylus pen 110 in a state in which it hovers over or touches the touch panel 100 receives the synchronizing signal b (S101) and then generates the second driving signal c having the same frequency as that of the first driving signal a (S102). Here, the first and second driving signals a and c may be a pulse wave, but are not limited thereto.

That is, when the synchronizing signal b is received from the touch panel 100 through the synchronizing signal receiving unit 112, the second controlling unit 114 generates the second driving signal c having the same frequency as that of the first driving signal a.

In addition, as shown in FIGS. 5 and 9, when the active stylus pen 110 applies the second driving signal c generated by the second controlling unit 114 to a hovering or touching point in a state in which it hovers over or touches the touch panel 100, the controller 120 detects a second sensed signal d by the second driving signal c to detect a coordinate of the hovering or touching point (S103).

That is, when the driving signal applying unit 113 applies the second driving signal c to the hovering or touching point two times in a state in which the active stylus pen 110 hovers over or touches the touch panel 100, the sensing circuit module 121 sequentially scans the first and second electrode patterns 101 and 102 to sense the second sensed signal d in which the change in mutual capacitance is reflected, and the first controlling unit 125 detects the coordinate of the hovering or touching point through the signal converting module 122 and the calculating module 123. Here, in the case in which the active stylus pen 110 hovers over the touch panel 100, there is no information on pressure data by the pressure sensing unit 111, and a plurality of pulses should be generated and sent out at the maximum magnitude so that the second driving signal c may be transferred to the touch panel 100.

As described above, according to the preferred embodiment of the present invention, since the active stylus pen 110 receives the synchronizing signal b from the touch panel 100 and then generates the second driving signal c to be applied to the touch panel 100, the touch panel 100 and the active stylus pen 110 may prevent a malfunction therebetween that may occur by applying the first and second driving signals a and c at the same timing, use the first and second driving signals a and c having the same frequency, and detect a touch input coordinate by the stylus pen using an existing controller without providing a separate sensing circuit unit for the second driving signal c in a touch module.

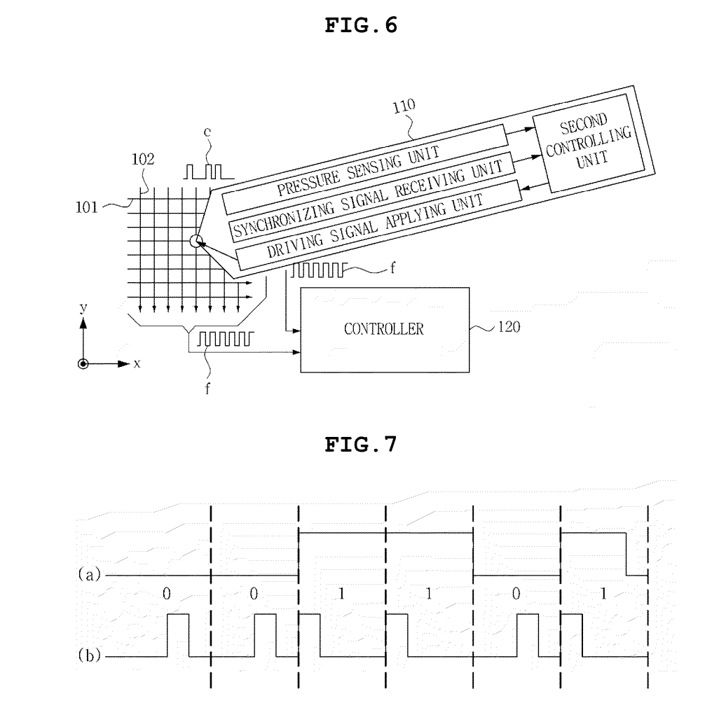

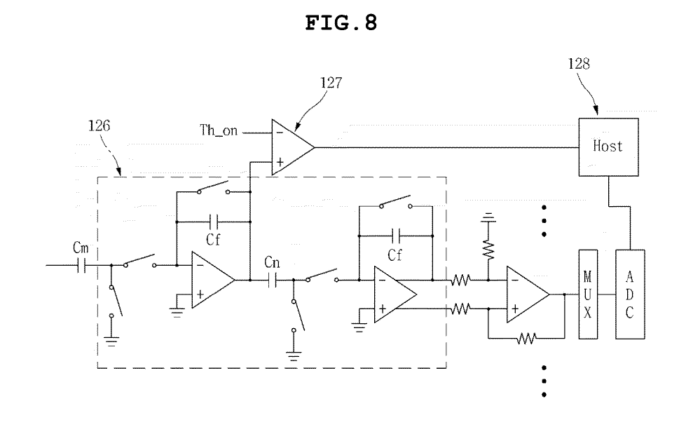

FIGS. 7A and 7B are views showing, respectively, modulated and encoded signals of sensed data measured by a pressure sensing unit according to the preferred embodiment of the present invention; FIG. 6 is a view for describing driving in the case in which the active stylus pen according to the preferred embodiment of the present invention touches the touch panel; and FIG. 8 is a view showing a sensing circuit module according to the preferred embodiment of the present invention.

As shown in FIG. 6, in a state in which the active stylus pen 110 touches the touch panel 100, pressure data of the active stylus pen 110 have meaningful information, and the second driving signal c may be easily transferred to the touch panel 100. Therefore, even though a magnitude of the second driving signal c or the number of pulses is decreased, a signal having a sufficient magnitude may be transferred to the touch panel 100 (S104).

That is, as shown in FIG. 7A, in the case in which pressure data (a pressure value=13) are measured in the pressure sensing unit 111 in the state in which the active stylus pen 110 touches the touch panel 100, the second controlling unit 114 modulates the pressure data (into a pulse wave) in an ON/OFF keying scheme. Then, as shown in FIG. 7B, in the case in which the ratio of ‘1’ in the pressure data is small, since a sufficient magnitude may not be sensed at the time of estimating a coordinate, the modulated pressure data are encoded using a Manchester code so as to allow ‘1’ in a predetermined ratio to be included in the pressure data, thereby generating the third driving signal e.

In addition, the driving signal applying unit 113 applies the third driving signal e to the touching point on the touch panel 100, the sensing circuit module 121 of the controller 120 sequentially scans the first and second patterns 101 and 102, respectively, to sense a third sensed signal f in which a change in mutual capacitance is reflected, and the first controlling unit 125 detects the coordinate of the touching point through the signal converting module 122 and the calculating module 123.

In addition, as shown in FIG. 8, a value at a timing at which each pulse of the third sensed signal is input to a non-inverting terminal of a comparator 127 connected to an integration circuit 126 included in the sensing circuit module 121 and a reference value Th_on of an inverting terminal of the comparator 127 are compared with each other, such that the pressure data measured in the pressure sensing unit are decoded, and a host server receives the decoded pressure data.

As described above, according to the preferred embodiment of the present invention, the third driving signal is generated based on the sensed data sensed by the pressure sensor, or the like, included in the active stylus pen 110 and is applied to the touch module, such that a separate communicating module for transferring the sensed data to the touch module is not required. Therefore, a manufacturing process of the active stylus pen may be simplified.

According to the preferred embodiment of the present invention, since the active stylus pen receives the synchronizing signal from the touch panel and then generates the second driving signal to be applied to the touch panel, the touch panel and the active stylus pen may prevent a malfunction therebetween that may occur by applying the first and second driving signals at the same timing, use the first and second driving signals having the same frequency, and detect a touch input coordinate by the stylus pen using an existing controller without providing a separate sensing circuit unit for the second driving signal in a touch module.

In addition, the third driving signal is generated based on the sensed data sensed by the pressure sensor, or the like, included in the active stylus pen and is applied to the touch module, such that a separate communicating module for transferring the sensed data to the touch module is not required. Therefore, a manufacturing process of the active stylus pen may be simplified.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel including an active stylus pen, comprising:
a touch panel including a plurality of first electrode patterns and second electrode patterns formed in directions in which they intersect with each other;
a controller controlling a first driving signal applied to the touch panel and detecting a change in mutual capacitance between the first and second electrode patterns by a touch input; and
the active stylus pen configured separately from the touch panel, and receiving a synchronizing signal from the touch panel when it hovers over or touches the touch panel, generates a second driving signal synchronized with the first driving signal, and outputs the generated second driving signal to the hovering or touching point.

2. The touch panel including an active stylus pen as set forth in claim 1, wherein the controller includes:
a driving circuit module applying a predetermined driving signal to the first electrode patterns;
a sensing circuit module sensing the change in mutual capacitance generated between the first and second electrode patterns and generating an analog signal corresponding to the change;
a signal converting module converting the analog signal into a digital signal;
a calculating module calculating a coordinate of the touch input applied to the touch panel using the digital signal; and
a first controlling unit controlling the driving circuit module, the sensing circuit module, and the signal converting module, and the calculating module.

3. The touch panel including an active stylus pen as set forth in claim 1, wherein the active stylus pen includes:
a synchronizing signal receiving unit receiving the synchronizing signal from the touch panel;
a driving signal applying unit generating a second driving unit to be applied to the touch panel after the reception of the synchronizing signal;
a pressure sensing unit sensing pressure when the active stylus pen touches the touch panel; and
a second controlling unit controlling the synchronizing signal receiving unit, the driving signal applying unit, and the pressure sensing unit.

4. The touch panel including an active stylus pen as set forth in claim 1, wherein the second driving signal has the same frequency as that of the first driving signal.

5. The touch panel including an active stylus pen as set forth in claim 3, wherein the second controlling unit generates a third driving signal based on data on a pressure value sensed by the pressure sensing unit.

6. The touch panel including an active stylus pen as set forth in claim 2, wherein the sensing circuit module includes a comparator.

7. A controlling method of a touch panel including an active stylus pen, comprising:
a touch recognizing step of detecting a change in mutual capacitance between first and second electrode patterns depending on a touch input according to a first driving signal sequentially applied to the touch panel to determine a position of the touch input;
a second driving signal generating step of allowing the active stylus pen hovering over or touching the touch panel to receive a synchronizing signal from the touch panel and generate a second driving signal synchronized with the first driving signal, after the touch recognizing step; and
a coordinate measuring step of the active stylus pen of detecting a change in mutual capacitance at the hovering or touching point by the active stylus pen to determine a coordinate of the hovering or touching point.

8. The controlling method as set forth in claim 7, wherein the first and second driving signals have the same frequency as each other.

9. The controlling method as set forth in claim 7, wherein the second driving signal generating step includes:
receiving, by a synchronizing signal receiving unit, the synchronizing signal from the touch panel after the touch recognizing step ends; and
generating, by a driving signal applying unit, the second driving signal to be applied to the touch panel after the receiving of the synchronizing signal.

10. The controlling method as set forth in claim 7, wherein the coordinate measuring step of the active stylus pen includes:
applying, by the active stylus pen, the second driving signal to the hovering or touching point on the touch panel; and
detecting the change in the mutual capacitance at the point to which the second driving signal is applied to determine a coordinate of the point.

11. The controlling method as set forth in claim 7, further comprising, after the coordinate measuring step of the active stylus pen, generating a third driving signal based on pressure data sensed by a pressure sensing unit and applying the generated third driving signal to the touch panel.
